(19) United States
(12) Patent Application Publication
(10) Pub. No.: US 2025/0372780 A1
(43) Pub. Date: Dec. 4, 2025

(54) BATTERY CASE AND RECHARGEABLE BATTERY CELL

(71) Applicant: TOYOTA BATTERY CO., LTD., Shizuoka (JP)

(72) Inventor: Yuji KATAYAMA, Okazaki-shi (JP)

(21) Appl. No.: 19/046,229

(22) Filed: Feb. 5, 2025

(30) Foreign Application Priority Data
May 29, 2024 (JP) 2024-086830

(51) Int. Cl. H01M 50/209; H01M 50/543; H01M 50/593

(52) U.S. Cl. CPC H01M 50/209; H01M 50/543; H01M 50/593

(57) ABSTRACT

An aspect of a battery case according to the present disclosure includes: a lower case with a first storage unit in which a first electrode body is stored and a second storage unit in which a second electrode body is stored and which is provided adjacent to the first storage unit; a first external terminal to which a first electrode terminal of the first electrode body is connected; an intermediate terminal which electrically connects a second electrode terminal of the first electrode body and a first electrode terminal of the second electrode body to each other; and a second external terminal to which a second electrode terminal of the second electrode body is connected.

### INCORPORATION BY REFERENCE

This application is based upon and claims the benefit of priority from Japanese patent application No. 2024-086830, filed on May 29, 2024, the disclosure of which is incorporated herein in its entirety by reference for all purposes.

### BACKGROUND

The present disclosure relates to, for example, a battery case and a rechargeable battery cell which store an electrode body.

In recent years, many assembled batteries that combine, in series, battery cells that output a constant output voltage are being used. In such an assembled battery, the number of battery cells constituting the assembled battery is set according to a desired output voltage. Accordingly, a technique related to a structure of combinable battery cells is disclosed in Japanese Unexamined Patent Application Publication No. 2015-56341.

In a battery module described in Japanese Unexamined Patent Application Publication No. 2015-56341, of a laminate made by stacking a plurality of power storage devices having foil-like lead terminals of a positive electrode and a negative electrode which protrude outward from the ends, lead terminals of different polarity of adjacent power storage devices are conductively connected to connecting members formed by extrusion molding of a metal material, respectively.

### SUMMARY

In recent years, rechargeable batteries often use an assembled battery in which a plurality of battery cells are combined to function as a single battery. In addition, there are many gaps between the rechargeable battery cells incorporated into an assembled battery, making miniaturization difficult. Accordingly, Japanese Unexamined Patent Application Publication No. 2015-56341 proposes a configuration in which, when constructing a laminate in which a plurality of power storage devices are stacked, the lead terminals of different polarity of the power storage devices are connected using a connecting member. However, with the battery module described in Japanese Unexamined Patent Application Publication No. 2015-56341, since each of the power storage devices is not sealed in a battery case, there is a problem in that the battery module cannot be applied when constructing an assembled battery using rechargeable battery cells in which an electrode body is sealed in a battery case.

The present disclosure has been made in view of the circumstances described above and an object thereof is to reduce a volume of an assembled battery including a rechargeable battery cell in plurality.

An aspect of a battery case according to the present disclosure includes: a lower case with a first storage unit in which a first electrode body is stored and a second storage unit in which a second electrode body is stored and which is provided adjacent to the first storage unit; a first external terminal to which a first electrode terminal of the first electrode body is connected; an intermediate terminal which electrically connects a second electrode terminal of the first electrode body and a first electrode terminal of the second electrode body to each other; and a second external terminal to which a second electrode terminal of the second electrode body is connected, wherein the first external terminal, the intermediate terminal, and the second external terminal are arranged on a terminal arrangement surface extending in a direction in which the first storage unit and the second storage unit are adjacent to each other in a surface of the lower case so that the intermediate terminal is located between the first external terminal and the second external terminal.

An aspect of a battery cell according to the present disclosure includes: a first electrode body and a second electrode body; a lower case which stores the first electrode body and the second electrode body; a first external terminal to which a first electrode terminal of the first electrode body is connected; an intermediate terminal which electrically connects a second electrode terminal of the first electrode body and a first electrode terminal of the second electrode body to each other; a second external terminal to which a second electrode terminal of the second electrode body is connected; and a lid which covers the lower case, wherein the first external terminal, the intermediate terminal, and the second external terminal are arranged on a terminal arrangement surface extending in a direction in which the first electrode body and the second electrode body are adjacent to each other in a surface of the lower case in a state where the first electrode body and the second electrode body are stored so that the intermediate terminal is located between the first external terminal and the second external terminal.

According to the battery case and the battery cell of the present disclosure, the number of battery cells required to construct an assembled battery that outputs a constant output voltage can be reduced.

The above and other objects, features and advantages of the present disclosure will become more fully understood from the detailed description given hereinbelow and the accompanying drawings.

### BRIEF DESCRIPTION OF DRAWINGS

FIG. 1 is a schematic diagram illustrating terminal components of a battery cell according to a first embodiment;

FIG. 2 is a schematic diagram illustrating a lower case and components associated to the lower case in a battery case according to the first embodiment;

FIG. 3 is a schematic diagram illustrating a shape of the battery cell according to the first embodiment; and

FIG. 4 is a diagram illustrating a current path of the battery cell according to the first embodiment.

### DESCRIPTION OF EMBODIMENTS

In the following description and in the drawings, omissions and abridgments have been made when appropriate for the sake of clarity. In the respective drawings, same elements are denoted by same reference signs and repetitive descriptions are omitted as needed. In addition, in the following description, a direction in which a long side of a battery cell extends is defined as a width direction X, a direction in which a short side of the battery cell extends is defined as a thickness direction Z, and a direction which is orthogonal to the width direction X and the thickness direction Z and which represents a height of the battery cell is defined as a height direction Y. Furthermore, in the following description, the width direction X may be referred to as a left-right direction and the height direction Y may be referred to as an up-down direction. Moreover, in the example to be described below, it is assumed that the battery cell is made up of two electrode bodies arranged in the width direction X of one battery case.

### First Embodiment

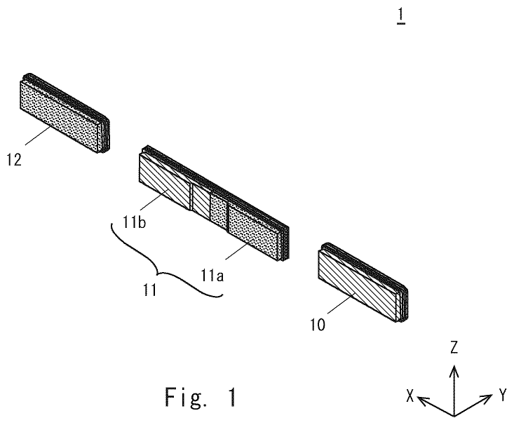

In a battery cell 1 according to a first embodiment, two electrode bodies are stored in a lower case integrally molded using an insulating resin by being arranged side by side in a longitudinal direction of the lower case. In addition, one of the features of the battery cell 1 according to the first embodiment is the configuration and structure of electrodes. Accordingly, FIG. 1 shows a schematic diagram illustrating terminal components of a battery cell according to the first embodiment.

As shown in FIG. 1, the battery cell 1 according to the first embodiment has a first external terminal (for example, an external positive electrode terminal 10), an intermediate terminal 11, and a second external terminal (for example, an external negative electrode terminal 12). In addition, a first electrode terminal (for example, a positive electrode) of a first electrode body is connected to the external positive electrode terminal 10. When the first electrode terminal is a positive electrode, the external positive electrode terminal 10 is formed by a metal containing aluminum as a principal component.

The intermediate terminal 11 electrically connects a second electrode terminal (for example, a negative electrode) of the first electrode body and a first electrode terminal (for example, a positive electrode) of a second electrode body to each other. Specifically, the intermediate terminal 11 is formed by joining an intermediate negative electrode terminal 11a and an intermediate positive electrode terminal 11b to each other. In addition, the intermediate negative electrode terminal 11a to which the negative electrode of an electrode body is connected is formed of a metal containing copper as a principal component and the intermediate positive electrode terminal 11b to which the positive electrode of an electrode body is connected is formed of a metal containing aluminum as a principal component. Furthermore, the intermediate terminal 11 is made by integrating the intermediate negative electrode terminal 11a and the intermediate positive electrode terminal 11b using a technique for dissimilar material bonding.

A second electrode terminal (for example, a negative electrode) of the second electrode body is connected to the external negative electrode terminal 12. When the second electrode terminal is a negative electrode, the external negative electrode terminal 12 is formed by a metal containing copper as a principal component.

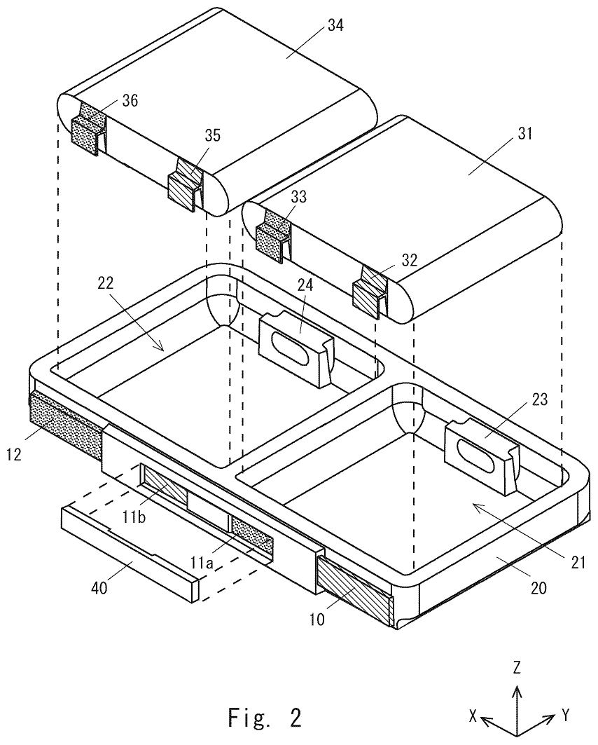

In the battery cell 1 according to the first embodiment, the external positive electrode terminal 10, the intermediate terminal 11, and the external negative electrode terminal 12 are insert-molded so as to be embedded in a resin constituting the lower case in a state of being arranged in a straight line in a width direction X of the battery cell 1 where the electrode bodies are lined up. Accordingly, FIG. 2 shows a schematic diagram illustrating a lower case and components associated to the lower case in a battery case according to the first embodiment.

As shown in FIG. 2, a lower case 20 of the battery cell 1 according to the first embodiment is insert-molded with the external positive electrode terminal 10, the intermediate terminal 11, and the external negative electrode terminal 12. In addition, a first storage unit 21 and a second storage unit 22 are formed in the lower case 20. Furthermore, in the lower case 20, the external positive electrode terminal 10, the intermediate terminal 11, and the external negative electrode terminal 12 are arranged on a terminal arrangement surface extending in a direction in which the first storage unit and the second storage unit 22 are adjacent to each other in a surface of the lower case 20 so that the intermediate terminal 11 is located between the external positive electrode terminal 10 and the external negative electrode terminal 12. In this case, the terminal arrangement surface refers to a surface in the lower case 20 which is bounded by first and second sides, in which case the longest side is the first side and the shortest side is the second side. In the example shown in FIG. 2, the first side is a side that extends in the width direction X and the second side is a side that extends in the thickness direction Z.

In addition, in the lower case 20, the resin is molded so that surfaces of the external positive electrode terminal 10 and the external negative electrode terminal 12 that face the outside of the lower case 20 and the back surfaces that face the first storage unit 21 and the second storage unit 22 are both exposed. Furthermore, in the intermediate terminal 11, the resin is molded so that surfaces of the intermediate negative electrode terminal 11a and the intermediate positive electrode terminal 11b that face the outside of the lower case 20 and the back surfaces that face the first storage unit 21 and the second storage unit 22 are both exposed. However, as shown in FIG. 2, the lower case 20 is molded so that the portion of the intermediate terminal 11 where the intermediate negative electrode terminal 11a and the intermediate positive electrode terminal 11b are joined to each other is covered with resin.

In this manner, since covering the junction surface of the intermediate negative electrode terminal 11a and the intermediate positive electrode terminal 11b with resin prevents the junction surface from being exposed to air, corrosion of the junction surface can be prevented.

In the battery cell 1 according to the first embodiment, an insulating cover 40 is provided at a position corresponding to the intermediate terminal 11. At least a surface of the insulating cover 40 is formed of an insulator. In one example, the insulating cover 40 is formed of an insulating material such as aluminum nitride. The insulating cover 40 has a shape that comes into contact with the intermediate negative electrode terminal 11a and the intermediate positive electrode terminal 11b that are exposed to the outside after resin formation. In this case, the insulating cover 40 preferably has a higher thermal conductivity than the resin that constitutes the lower case 20. Forming the insulating cover 40 with a material with a high thermal conductivity in this manner enables the insulating cover 40 to function as a heat-dissipating component that promotes the release of heat generated by the battery cell 1. In other words, using a member that has high insulation and heat dissipation as the insulating cover 40 enables the insulating cover 40 to have both insulation and heat dissipation functions.

As shown in FIG. 2, a first electrode body 31 is stored in the first storage unit 21 and a second electrode body 34 is stored in the second storage unit 22. In this storage state, a positive electrode tab 32 of the first electrode body 31 is joined to the external positive electrode terminal 10. A negative electrode tab 33 of the first electrode body 31 is joined to the intermediate negative electrode terminal 11a. In addition, in the storage state, a positive electrode tab 35 of the second electrode body 34 is joined to the intermediate positive electrode terminal 11b. A negative electrode tab 36 of the second electrode body 34 is joined to the external negative electrode terminal 12.

In addition, as shown in FIG. 2, a smoke exhaust port 23 is formed in the first storage unit 21 and a smoke exhaust port 24 is formed in the second storage unit 22. The smoke exhaust ports 23 and 24 are provided on a surface (hereinafter, referred to as a case bottom surface) opposite the surface on which the external positive electrode terminal 10, the intermediate terminal 11, and the external negative electrode terminal 12 are provided. The smoke exhaust ports 23 and 24 have a T-shape and are high enough that an upper surface with a large area is in contact with a surface (referred to as an electrode body bottom surface) opposite the surface where the electrode tabs of the first electrode body 31 and the second electrode body 34 are formed. Using the smoke exhaust ports 23 and 24, the battery cell 1 supports the bottom surfaces of the electrode bodies in the storage state with the members that constitute the smoke exhaust ports.

In addition, the smoke exhaust ports 23 and 24 are provided with holes that penetrate through a member formed in a shape that supports the first electrode body 31 and the second electrode body 34. Furthermore, an open valve (not illustrated) is provided in the holes to discharge gas inside each storage unit to the outside when the internal pressure of the storage unit rises. Due to the open valve, the battery cell 1 is designed so that the internal pressure in the storage units does not rise beyond a certain level.

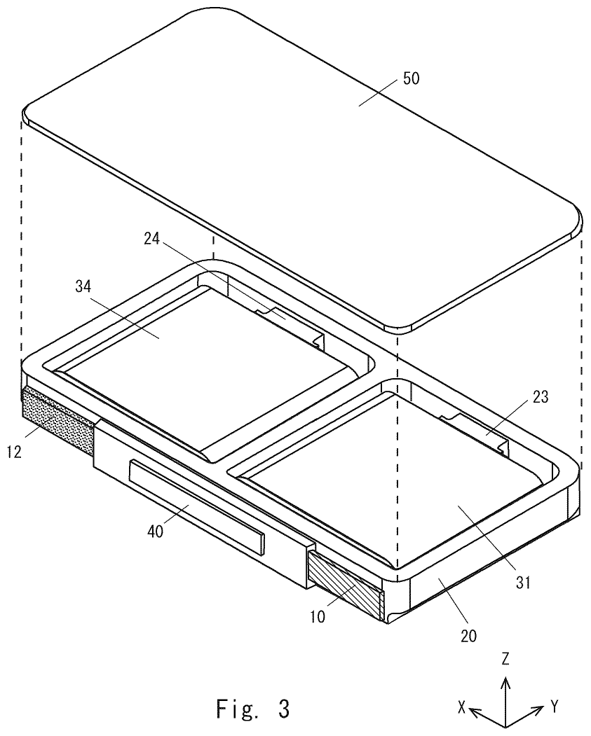

Next, FIG. 3 shows a schematic diagram illustrating a shape of the battery cell according to the first embodiment. FIG. 3 is a diagram that illustrates a state in which the first electrode body 31 and the second electrode body 34 illustrated in FIG. 2 are stored in the respective storage units and a lid 50 is placed over the lower case 20 to which the insulating cover 40 is attached. In the battery cell 1 according to the first embodiment, after storing the first electrode body 31 and the second electrode body 34 in the respective storage units, an electrolytic solution is injected into each storage unit to impregnate each electrode body with the electrolytic solution and, subsequently, the lid 50 is glued to the lower case 20 so as to cover the first storage unit 21 and the second storage unit 22.

Although FIG. 3 shows an example where one lid 50 is provided with respect to two storage units, the lid 50 can be prepared as a separate member for each storage unit. In this manner, by providing a lid for each storage unit, advantageous effects can be obtained including being able to easily weld the lids and being able to change the shape of the lid according to the variation of each electrode body and adjust applied pressure to each electrode body.

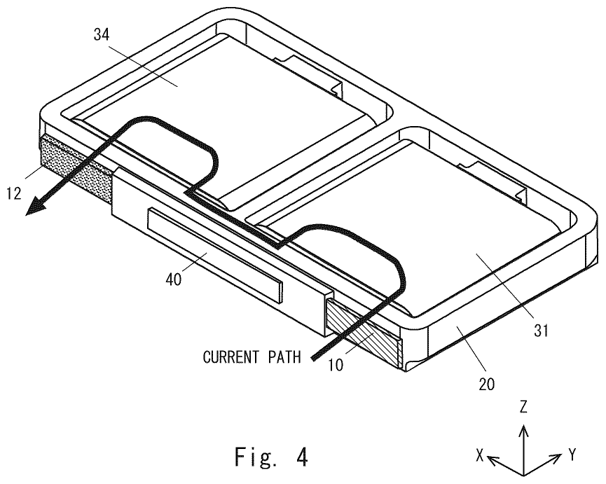

Next, a current path in the battery cell 1 manufactured in this manner will be described. FIG. 4 shows a diagram illustrating a current path of the battery cell according to the first embodiment. As shown in FIG. 4, in the battery cell 1 according to the first embodiment, since the external positive electrode terminal 10, the intermediate terminal 11, and the external negative electrode terminal 12 are arranged in a straight line on the same surface, a current path passes through the electrode body close to the terminal arrangement surface and is formed by a path with less meandering with respect to the terminal arrangement surface. Accordingly, the battery cell 1 according to the first embodiment enables resistance to be reduced as a battery.

From the description presented above, in the battery cell 1 according to the first embodiment, the use of the intermediate terminal 11 enables two electrode bodies to be stored in one case. Storing two electrode bodies in one battery cell in a state of being connected by intermediate terminals insert-molded into the lower case 20 in this manner enables the number of components for connecting the cells and gaps to be reduced and two cells' worth of power to be outputted. In addition, constructing an assembled battery using such battery cells enables a volume of the assembled battery to be reduced.

In addition, in the battery cell 1, since a portion where different members are joined in the intermediate terminal 11 is covered with a resin, corrosion of the junction surface between the intermediate negative electrode terminal 11a and the intermediate positive electrode terminal 11b can be prevented. Furthermore, in the battery cell 1, safety can be enhanced by providing the insulating cover 40 with high insulation properties. Moreover, thermal dissipation performance of the battery cell 1 can be enhanced by providing the insulating cover 40 with high thermal conductivity.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims. For example, while the first external terminal has been described as a negative electrode terminal and the second external terminal has been described as a positive terminal in the description given above, reversing the electrode terminals is easily conceivable.

What is claimed is:

1. A battery case, comprising:
a lower case with a first storage unit in which a first electrode body is stored and a second storage unit in which a second electrode body is stored and which is provided adjacent to the first storage unit;
a first external terminal to which a first electrode terminal of the first electrode body is connected;
an intermediate terminal which electrically connects a second electrode terminal of the first electrode body and a first electrode terminal of the second electrode body to each other; and
a second external terminal to which a second electrode terminal of the second electrode body is connected,
wherein the first external terminal, the intermediate terminal, and the second external terminal are arranged on a terminal arrangement surface extending in a direction in which the first storage unit and the second storage unit are adjacent to each other in a surface of the lower case so that the intermediate terminal is located between the first external terminal and the second external terminal.

2. The battery case according to claim 1, wherein the intermediate terminal is covered by an insulating cover of which at least a surface is constituted of an insulator.

3. The battery case according to claim 2, wherein the insulating cover has a higher thermal conductivity than a material that constitutes the lower case.

4. The battery case according to claim 1, wherein when a longest side of the lower case is a first side and a shortest side of the lower case is a second side, the terminal arrangement surface is a surface that is bounded by the first side and the second side.

5. The battery case according to claim 1, wherein the intermediate terminal is fixed in a state of being insert-molded by a resin that forms the first storage unit and the second storage unit.

6. The battery case according to claim 5, wherein the intermediate terminal has a structure in which different members are joined together and the joined portion is covered by the resin.

7. The battery case according to claim 1, wherein the first external terminal and the second external terminal are fixed in a state of being insert-molded by a resin that forms the first storage unit and the second storage unit.

8. A battery cell, comprising:
a first electrode body and a second electrode body;
a lower case which stores the first electrode body and the second electrode body;
a first external terminal to which a first electrode terminal of the first electrode body is connected;
an intermediate terminal which electrically connects a second electrode terminal of the first electrode body and a first electrode terminal of the second electrode body to each other;
a second external terminal to which a second electrode terminal of the second electrode body is connected; and
a lid which covers the lower case,
wherein the first external terminal, the intermediate terminal, and the second external terminal are arranged on a terminal arrangement surface extending in a direction in which the first electrode body and the second electrode body are adjacent to each other in a surface of the lower case in a state where the first electrode body and the second electrode body are stored so that the intermediate terminal is located between the first external terminal and the second external terminal.
